(19) United States
(12) Patent Application Publication
(10) Pub. No.: US 2026/0141124 A1
(43) Pub. Date: May 21, 2026

(54) ELECTRONIC DEVICE

(71) Applicant: STMicroelectronics International N.V., Geneva (CH)

(72) Inventors: Alexandre SARAFIANOS, Pourrieres (FR); Mathieu LISART, Aix en Provence (FR); Hafsa EL ALAMI, Aix en Provence (FR)

(73) Assignee: STMicroelectronics International N.V., Geneva (CH)

(21) Appl. No.: 19/390,954

(22) Filed: Nov. 17, 2025

(30) Foreign Application Priority Data
Nov. 19, 2024 (FR) FR2412655

(51) Int. Cl. G06F 21/75; H03K 19/003; H03K 19/20

(52) U.S. Cl. CPC G06F 21/755; H03K 19/003; H03K 19/20

(57) ABSTRACT

An electronic device includes a logic gate coupled to a first node of application of a reference voltage, a random voltage generator configured to generate a random voltage at a second node, and a first diode having a cathode coupled to the second node and an anode coupled to the first node.

### PRIORITY CLAIM

This application claims the priority benefit of French Application for Patent No. FR2412655, filed on November 19, 2024, the content of which is hereby incorporated by reference in its entirety to the maximum extent allowable by law.

### TECHNICAL FIELD

The present disclosure generally concerns an electronic device and more particularly an electronic device protected against laser scanning attacks.

### BACKGROUND

There exist many hacking techniques enabling individuals to obtain information contained on a chip. For example, said individuals may seek to determine the binary information contained in the logic circuits of the electronic chip. One of the hacking techniques is laser scanning.

There exists a need to protect chips from laser scanning.

There is a need to overcome all or part of the disadvantages of known electronic devices with respect to hacking techniques.

### SUMMARY

An embodiment provides an electronic device comprising: a logic gate coupled to a first node of application of a reference voltage; a random voltage generator configured to generate a random voltage at a second node; and a first diode having an anode coupled to the first node and a cathode coupled to the second node.

Another embodiment provides a method of use of an electronic device which comprises a logic gate coupled to a first node, a random voltage generator and a first diode having a cathode and an anode coupled to the first node, the method comprising generating with the random voltage generator a random voltage at the cathode and applying a reference voltage to the first node and anode node.

According to an embodiment, the logic gate is a logic circuit comprising one of: an inverter, a logic AND gate, a logic NAND gate, an inclusive OR gate, an inclusive NOR gate, an exclusive OR gate, or an exclusive NOR gate.

According to an embodiment, the device comprises a first region comprising a plurality of logic gates and a plurality of first diodes.

According to an embodiment, a density of first diodes is greater than five per mm² in the first region.

According to an embodiment, at least two first diodes have different dimensions.

According to an embodiment, at least two first diodes have different structures.

According to an embodiment, at least one first diode comprises a PN junction formed between a well of a first conductivity type and a substrate of the device of a second conductivity type, opposite to the first conductivity type.

According to an embodiment, at least one first diode comprises a PN junction formed between a first well of a first conductivity type and a second well of a second conductivity type, opposite to the first conductivity type, the second well being located in the first well.

According to an embodiment, the random voltage generator is configured to generate at least two distinct random voltages, each of the two distinct random voltages being applied to the cathode of at least one first diode.

According to an embodiment, the random voltage generator comprises: an input coupled to a node of application of a clock signal; at least one circuit module configured to receive as an input a random number and to modify the clock signal as a function of the random number.

According to an embodiment, the random voltage generator comprises a circuit module configured to modify an amplitude of the clock signal as a function of a random number.

According to an embodiment, the random voltage generator comprises a circuit module configured to divide a frequency of the clock signal.

According to an embodiment, the random voltage generator comprises at least one random switching circuit module.

According to an embodiment, the random voltage generator comprises a circuit module configured to add a delay to a clock signal.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1A, FIG. 1B, and FIG. 1C illustrate the principle of laser scanning;

FIG. 2 illustrates an embodiment of an electronic device protected against laser scanning;

FIG. 3 schematically shows an embodiment of a device protected against laser scanning;

FIG. 4 schematically shows an embodiment of a device protected against laser scanning;

FIG. 5 schematically shows in top view an embodiment of a device protected against laser scanning;

FIG. 6 shows an embodiment of an electronic device comprising a random voltage generator; and

FIG. 7 illustrates the operation of the random voltage generator of FIG. 6.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

Further, the embodiments described hereafter are particularly adapted to being used in any type of industrial market where a logic circuit, preferably secure, is necessary. More particularly, such a logic circuit may be intended for: the automotive industry, for example in the field of automotive electrification or in the field of advanced driver assistance systems (ADAS); the industrial sector, for example in the field of green energy, in the field of infrastructure electrification, of the Internet of Things (IoT) and of smart homes, where electricity and energy consumption and data exchange are key elements; the personal electronics industry, for example in the field of mobile telephony and of the Internet of Things (IoT), as well as in the field of high-speed interfaces; and the industry of communications equipment, computers, and peripherals, for example in the field of infrastructures and data centers, and in the field of low earth orbit (LEO) satellites.

The expression "logic gate" is used to designate an electronic circuit performing logical (Boolean) operations on a bit sequence. This sequence is given by a square-wave modulated input signal, precisely clocked by a clock circuit, or quartz. Logic gates include inverter (INV) gates, logic AND gates, the logic NAND gates, inclusive OR gates, inclusive NOR gates, exclusive OR gates, or exclusive NOR gates.

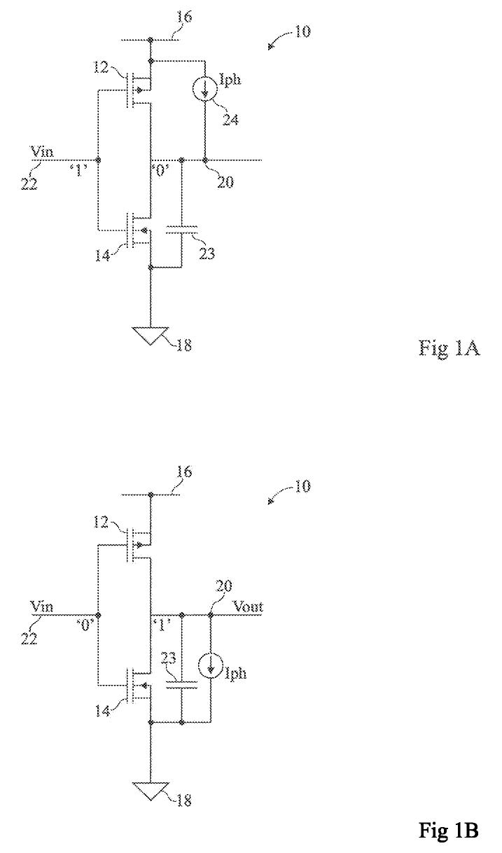

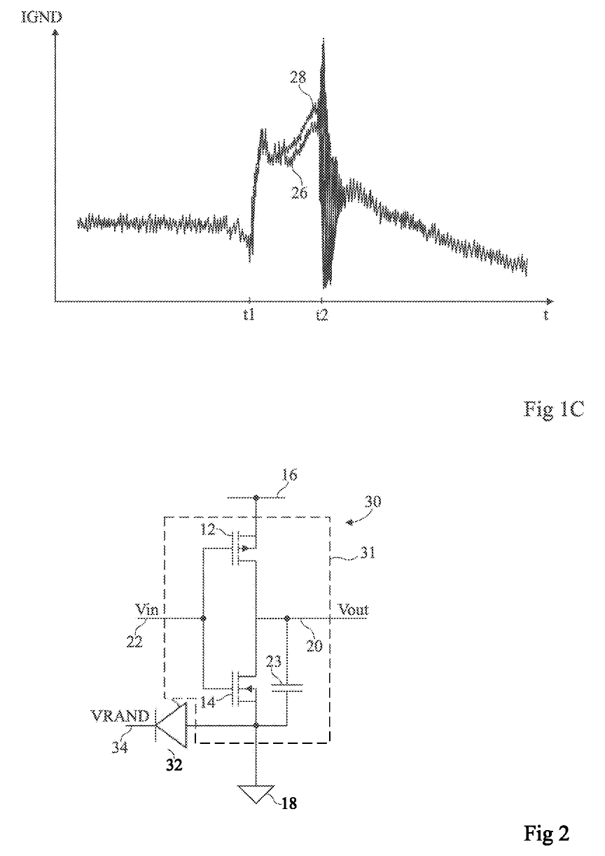

FIG. 1A, FIG. 1B, and FIG. 1C illustrate the principle of laser scanning. More specifically, FIG. 1A shows a logic circuit, in a first state, on which a laser scanning is performed. FIG. 1B shows the same logic circuit in a second state, on which a laser scanning is performed. FIG. 1C shows a reference current IGND of the logic circuit in the circuits of FIGS. 1A and 1B.

FIGS. 1A and 1B show an inverter (INV) gate circuit 10. Circuit 10 comprises two transistors 12 and 14. Transistors 12 and 14 are, for example, CMOS-type transistors. Transistor 12 is, for example, a PMOS-type transistor. Transistor 14 is, for example, an NMOS-type transistor. Transistors 12 and 14 are coupled in series between a power supply voltage node 16 and a reference voltage node 18. More specifically, a first power supply node of the logic circuit inverter 10 at the source of transistor 12 is, for example, coupled, preferably connected, to node 16 (to receive a power supply voltage (for example, VDD)) and the drain of transistor 12 is, for example, coupled, preferably connected, to an output node 20, at which an output voltage Vout is generated. A second power supply node of the logic circuit inverter 10 at the source of transistor 14 is, for example, coupled, preferably connected, to node 18 (to receive a reference supply voltage (for example, ground)) and the drain of transistor 14 is, for example, coupled, preferably connected, to output node 20. The control nodes of transistors 12 and 14 are coupled, preferably connected, to each other and to an input node 22 having an input voltage Vin applied thereto. Circuit 10 further comprises a capacitor 23 coupled between nodes 20 and 18.

In FIG. 1A, circuit 10 receives as an input a binary value '1' and outputs a binary value '0'. In FIG. 1B, circuit 10 receives as an input a binary value '0' and outputs a binary value '1'.

During a laser scanning, a laser beam is directed so as to reach (i.e., be applied at) circuit 10, for example the drain of transistor 14. The application of the laser beam induces the generation of electron-hole pairs at node 20, and thus the generation of a current Iph in circuit 10. Current Iph is represented in FIGS. 1A and 1B by a positive current source 24. The location of current Iph, that is, the location of source 24, depends on the state of the logic circuit.

In the case of FIG. 1A, that is, in the case where the output of circuit 10 corresponds to a binary value '0', transistor 14 is on and transistor 12 is off. Thus, the source 24 representing current Iph is located between node 16 and node 20.

In the case of FIG. 1B, that is, in the case where the output of circuit 10 delivers a signal corresponding to a binary value '1', transistor 14 is off and transistor 12 is on. Thus, the source 24 representing current Iph is located between node 18 and node 20.

FIG. 1C shows reference current IGND, that is, the current flowing through node 18, that is, the total current seen on ground, as a function of time. FIG. 1C comprises a curve 26 corresponding to current IGND in the case of the circuit 10 of FIG. 1A, and a curve 28 corresponding to current IGND in the case of the circuit 10 of FIG. 1B.

Between times t1 and t2, a laser beam is applied to node 20, for example to the drain of transistor 14. One can thus observe in FIG. 1C the impact of the state of circuit 10 on current IGND. More precisely, the current IGND corresponding to curve 26 is lower, between times t1 and t2, than the current IGND corresponding to curve 28. This difference is caused by current Iph, which flows through node 18 in the case of FIG. 1B and not in the case of FIG. 1A.

The significant difference between curves 26 and 28 enables, by measuring current IGND and by applying the laser beam to circuit 10, to determine the state of circuit 10.

FIG. 2 illustrates an embodiment of an electronic device protected against laser scanning. More specifically, FIG. 2 shows a circuit 30 configured with protection against laser scanning attacks.

Circuit 30 comprises a logic gate 31. The logic gate comprises an input having a voltage Vin, corresponding to an input binary value, applied thereto. Logic gate 31 comprises an output having an output voltage Vout, corresponding to an output binary value, applied thereto.

Logic gate 31 comprises a first power supply node coupled, preferably connected, to the node 16 of application of a power supply voltage (for example, VDD). Logic gate 31 further comprises a second power supply node coupled, preferably connected, to the node 18 of application of a reference supply voltage (for example, ground).

In the example of FIG. 2, the logic gate is an inverter (INV) gate. Circuit 30 thus comprises the elements of the previously-described circuit 10. Logic gate 31 thus comprises transistors 12 and 14 and capacitor 23 arranged and coupled as described in relation with FIGS. 1A and 1B.

Circuit 30 further comprises a diode 32 coupled between a node 34 and node 18. More specifically, the cathode of diode 32 is coupled, preferably connected, to node 34 and the anode of diode 32 is coupled, preferably connected, to node 18.

Node 34 is a node of application of a random voltage VRAND, that is, a voltage having a value and variations of which that are random. Voltage VRAND is thus independent of voltage Vout at node 20, independent of voltage Vin at node 22, and independent of the power supply voltage at node 16. Voltage VRAND is not a constant voltage. Voltage VRAND is, for example, a periodic voltage having its amplitude and period randomly changed.

The application of the laser beam to the circuit causes the forming of a current through diode 32. Said current thus has a constant value, preferably zero, in the absence of a laser beam, and a variable value, depending on voltage VRAND, on application of the laser beam.

The random current flowing through diode 32 adds to the reference current shown in FIG. 1C. The adding of a random portion to the reference current enables to ensure that it is no longer possible to identify a significant difference between the reference current in the case where the output of circuit 10 is in a first binary state and the reference current in the case where the output of circuit 10 is in a second binary state.

The diode is preferably dedicated to providing laser scanning protection. Thus, the cathode of diode 32 receives no voltage other than voltage VRAND.

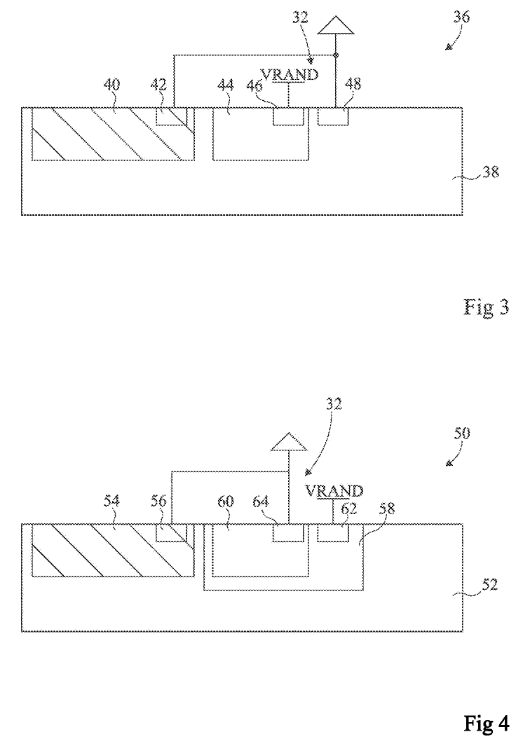

FIG. 3 schematically shows an embodiment of a device protected against laser scanning. More specifically, FIG. 3 schematically shows an implementation mode of the diode 32 of FIG. 2.

FIG. 3 shows an electronic device 36. The device 36 is, for example, an electronic chip. Device 36 comprises a semiconductor substrate 38 of a first conductivity type. Substrate 38 is, for example, a P-doped substrate.

Device 36 comprises, for example, one or a plurality of logic circuit regions 40. By logic circuit region, there is meant circuit regions in which are formed the components, for example, the transistors, of logic circuits or gates. For example, the transistors 12 and 14 of circuit 30 may be formed in region 40. Region 40 comprises, for example, semiconductor wells, for example at least wells of a second conductivity type, for example of type N. Region 40 preferably comprises at least one more heavily doped region 42 coupled, preferably connected, to ground node 18.

Device 36 comprises a well 44. Well 44 is made of a doped semiconductor material of a second conductivity type, opposite to the first conductivity type. Well 44 is, for example, N-type doped. The interface between well 44 and substrate 38 forms diode 32.

Well 44 comprises, for example, a more heavily doped region 46 of the same conductivity type as well 44. Region 46 is coupled, preferably connected, to the output of a random voltage source circuit. Thus, region 46 receives a random voltage VRAND.

Substrate 38 comprises, for example, a more heavily-doped region 48 of the same conductivity type as substrate 38. Region 48 is coupled, preferably connected, to region 42. Region 48 is, for example, coupled, preferably connected, to a source of the reference voltage.

FIG. 4 schematically shows an embodiment of a device protected against laser scanning. More specifically, FIG. 3 schematically shows another implementation mode of the diode 32 of FIG. 2.

FIG. 4 shows an electronic device 50. Device 50 is, for example, an electronic chip. Device 50 comprises a semiconductor substrate 52 of the first conductivity type. Substrate 52 is, for example, a P-doped substrate.

Device 50 comprises, for example, one or a plurality of logic circuit regions 54 identical to the logic circuit regions 40 described in relation with FIG. 3. The logic circuit regions comprise, for example, semiconductor wells 56 identical to the well 42 described in relation with FIG. 3.

Device 50 comprises a well 58 located in substrate 52. The well 58 is made of a doped semiconductor material of the second conductivity type. Well 58 is, for example, N-type doped.

Device 50 comprises a further well 60. Well 60 is made of a doped semiconductor material of the first conductivity type, that is, the conductivity type of substrate 52. Well 60 is, for example, P-type doped. Well 60 is located in well 58.

The interface between well 58 and well 60 forms diode 32.

Well 58 comprises, for example, a more heavily doped region 62 of the same conductivity type as well 58. Region 62 is coupled, preferably connected, to the output of a random voltage source. Thus, region 62 receives a random voltage VRAND.

Well 60 comprises, for example, a more heavily doped region 64 of the same conductivity type as well 60. Region 64 is coupled, preferably connected, to region 56. Region 64 is, for example, coupled, preferably connected, to a source of the reference voltage.

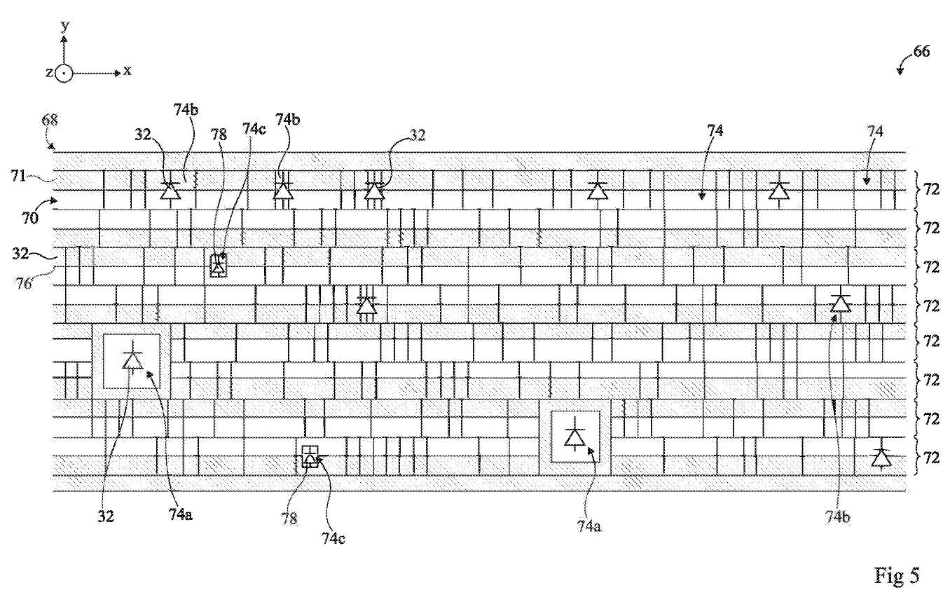

FIG. 5 schematically shows in top view an embodiment of a device 66 protected against laser scanning. Device 66 is, for example, an electronic chip. Device 66 comprises, for example, logic circuits. FIG. 5 shows a portion of device 66 comprising logic circuits.

Device 66 comprises a substrate 68. Substrate 68 is made of a semiconductor material. Substrate 68 is doped with the first conductivity type, for example type P.

Device 66 further comprises at least one well 70, for example at least two wells 70, for example at least ten wells 70. Wells 70 are located in substrate 68. Wells 70 are made of a semiconductor material, for example the same material as substrate 68. The wells 70 are doped with the second conductivity type, that is, the type opposite to the conductivity type of substrate 68. For example, the wells 70 are N-type doped.

Wells 70 are preferably flush with the surface of substrate 68. Wells 70 form rows extending along an X axis. Wells 70 preferably extend in directions parallel to one another. Preferably, each well 70 has a substantially constant dimension along a Y axis.

Wells 70 are separated from one another by regions 71 of substrate 68. The regions 71 of substrate 68 separating the wells 70 preferably extend over the entire height of wells 70. The regions 71 of substrate 68 located between wells 70 have, for example, a substantially constant dimension along a Y axis.

Device 66 thus comprises, at the substrate surface, an alternation of wells 70 and of regions 71 of substrate 68 along the Y axis.

For example, wells 70 may be located on a same row along the X axis. Said wells 70 are then aligned along the X axis. Said wells 70 of a same row are separated from one another by regions 71 of substrate 68.

Device 66 comprises rows 72 of cells 74. The rows preferably extend along the X axis. Rows 72 are thus preferably parallel to one another. Each row 72 preferably comprises at least two cells 74, for example at least ten cells.

Each cell 74 comprises a portion of wells 70 and a portion of regions 71 of substrate 68. Thus, each cell 74 comprises, at the surface of substrate 68, a portion of well 70, and a portion of a region 71. Each cell 74 thus comprises a P-N interface. Preferably, each cell 74 comprises a P-N interface at the surface of substrate 68.

Each cell 74 is, for example, surrounded by an insulating wall 76.

Preferably, all the cells 74 in a same row 72 have the same dimensions along the Y axis. Preferably, all the cells 74 in a same row 72 have the same dimensions along the Y axis, with the exception of cells 74a. Each cell 74a has a dimension along the Y axis substantially equal to the sum of the dimensions along the Y axis of the rows in which it is located. Two cells 74a are shown in FIG. 5. The two cells 74a of FIG. 5 have a dimension along the Y axis equal to the sum of the dimensions of two rows 72. Thus, the cells 74a of FIG. 5 extend over two rows 72.

Preferably, each cell 74 comprises at least one electronic component. By electronic component, there is meant an element, active or passive, intended to be assembled with others in order to perform one or a plurality of electronic functions. For example, the components may be transistors, resistors, diodes, capacitors, or inductors.

Device 66 comprises cells 74b comprising diodes 32, such as previously described, enabling to protect circuits from laser scanning attacks. Preferably, each cell 74b comprises a single diode 32. Preferably, each cell 74b only comprises a diode 32.

Further, device 66 comprises cells 74c. Each cell 74c comprises an electronic component and a diode 32. The component is, for example, a transistor. Diode 32 is, for example, located in a well 78 located in cell 74c.

The cathodes of all diodes 32 are, for example, coupled, preferably connected, to the node 18, not shown, of application of the reference voltage, for example ground.

The anode of each diode 32 is coupled, preferably connected, to a source of a random voltage. Device 66 thus comprises a random voltage generator. Preferably, the random voltage generator is configured to generate at least two distinct random voltages. Diodes 32 preferably do not all receive the same random voltage. Preferably, diodes 32 receive a random voltage from among at least two random voltages generated by the random voltage generator.

According to an embodiment, the anode of each diode 32 receives a random voltage distinct from the random voltages received by the other diodes 32. The random voltage generator is then configured to generate at least as many random voltages as there are diodes 32 and device 66.

According to another embodiment, at least two diodes 32 receive the same random voltage. Preferably, a same random voltage is not delivered to diodes of a same row. Thus, the diodes 32 of a same row preferably all receive different random voltages.

Diodes 32 are preferably distributed in device 66, preferably distributed over the entire region comprising the logic circuit elements. Preferably, each row 72 comprises at least one diode 32, for example at least two diodes 32. Preferably, the density of diodes 32 in the rows 72 is at least five diodes 32 per hundred square micrometers, preferably at least ten diodes 32 per hundred square micrometers.

Preferably, device 66 does not comprise two adjacent diodes 32. In other words, each diode 32 is separated from the other diodes 32 by at least one cell 72 comprising no diode 32.

Preferably, device 66 comprises at least two types of diodes 32. For example, device 66 comprises at least one diode 32 such as that described in relation with FIG. 3 and at least one diode such as that described in relation with FIG. 4.

For example, device 66 comprises at least two diodes having different dimensions. For example, device 66 comprises at least two diodes having P-N interfaces, that is, the contact surface between the cathode and the anode, having different dimensions.

For example, device 66 comprises at least two diodes 32 having different doping values.

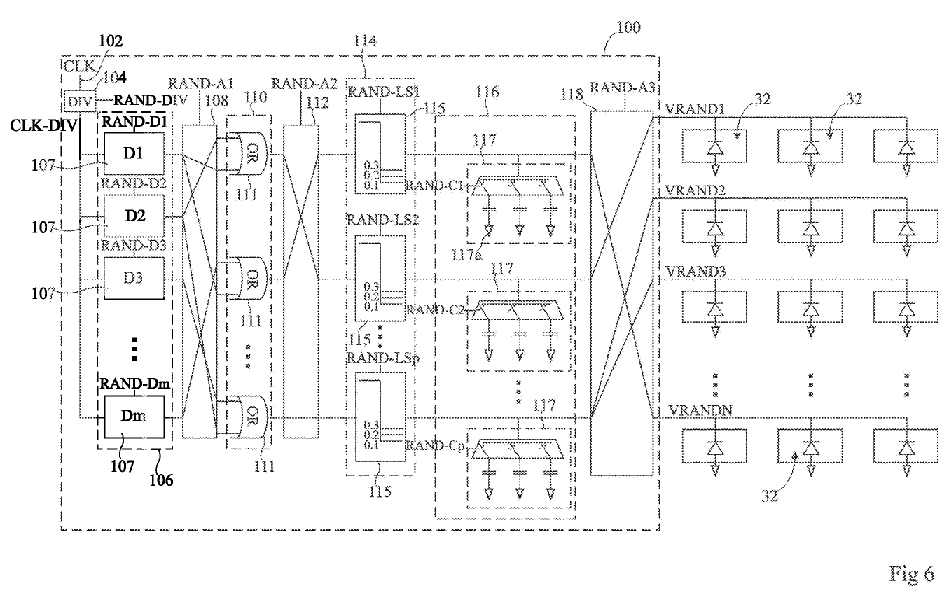

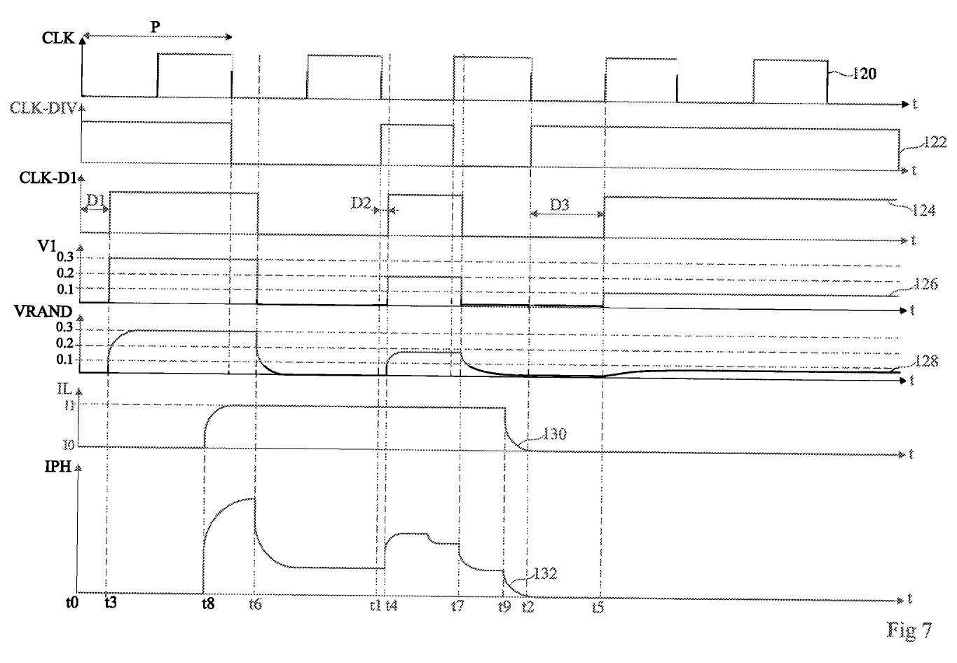

FIG. 6 shows an embodiment of a random voltage generator 100. Generator 100 is, for example configured to generate a plurality of random voltages. In FIG. 6, generator 100 is configured to generate N random voltages (VRAND1, VRAND2, VRAND3, ..., VRANDN), value N being greater than 3. Generator 100 thus comprises N outputs, random voltages being

generated at each output. Each output is coupled, preferably connected, to the cathode of at least one diode 32. In the example of FIG. 6, each output of generator 100 is coupled, preferably connected, to the cathode of three diodes 32.

Generator 100 comprises a first input 102. The generator is configured to receive, at input 102, a clock signal CLK, that is, a periodic oscillating voltage, for example a square signal, having a constant period.

Generator 100 comprises at least one second input, not shown. The second input is configured to receive a random value. Each second input is coupled, preferably connected, to an output of a random number generator. The random number generator is, for example, a physical random number generator. The random number generator generates, for example, random numbers for data encryption and/or decryption. The values of the random numbers supplied to the outputs of the random number generator are variable. Thus, the values of the random numbers supplied to the outputs of the random number generator change at every cycle of a clock signal, for example every cycle of clock signal CLK.

Generator 100 comprises at least one circuit module configured to modify the clock signal so as to obtain a random voltage. Each circuit module depends on at least one random value received on a second input. Several types of circuit modules are shown in FIG. 6, arranged in a certain order. The generator may have any number of circuit modules arranged in any order, and certain types of circuit modules may be present a plurality of times. The generator may further comprise other types of circuit modules enabling to modify the clock signal so as to obtain a random voltage.

In the example of FIG. 6, generator 100 comprises a circuit module 104 configured to divide the frequency of the clock signal by a random value. Circuit module 104 comprises a first input configured to receive clock signal CLK and a second input configured to receive a random value RAND-DIV. The first input of circuit module 104 is coupled, preferably connected, to the first input 102 of generator 100. The second input of circuit module 104 is coupled, preferably connected, to a second input of generator 100. Circuit module 104 comprises an output on which a CLK-DIV signal is generated. Signal CLK-DIV is equal to signal CLK having a frequency divided by random value RAND-DIV.

In the example of FIG. 6, generator 100 comprises a circuit module 106. Circuit module 106 is configured to add delays, preferably distinct from one another, preferably different from one another, to each signal received as an input. In the example of FIG. 6, circuit module 106 comprises m first inputs configured to receive a voltage. In the example of FIG. 6, said m first inputs are coupled, preferably connected, to the output of circuit module 104. Said first inputs thus all receive the same voltage CLK-DIV. Number m has a value greater than or equal to 1, preferably greater than or equal to 3. Circuit module 106 further comprises m second inputs, configured to each receive a random number (RAND-D1, RAND-D2, RAND-D3, RAND-Dm), preferably distinct from the other random numbers received on the other second inputs of circuit module 106. Said second inputs are coupled, preferably connected, to outputs, preferably different outputs, of the random number generator.

In the example of FIG. 6, circuit module 106 comprises m elements 107 (D1, D2, D3, ..., Dm). Each element 107 comprises a first input configured to receive a voltage and a second input configured to receive a random number. Each first input is coupled, preferably connected, to a first input of circuit module 106 and is thus coupled, preferably connected, to the output of circuit module 104.

Each circuit module 107 is configured to add a delay to the signal received on the first input of the element. The delay added by each element 107 depends on the random value received by element 107.

In the example of FIG. 6, generator 100 comprises a random switching circuit module 108. Circuit module 108 comprises m first inputs, each input being coupled, preferably connected, to the output of an element 107. Thus, the output of each element 107 is coupled, preferably connected, to a first input of circuit module 108. Circuit module 108 comprises a second input, configured to receive a random value RAND-A1, generated by a random value generator. The second input of circuit module 108 is, for example, coupled, preferably connected, to an output of the random number generator.

Circuit module 108 comprises outputs. For example, circuit module 108 comprises an even number of outputs. Circuit module 108 comprises, for example, a number of outputs different from, for example greater than, the number of inputs. Each output of circuit module 108 is coupled, preferably connected, to a first input of circuit module 108. The first input to which is coupled, preferably connected, each output depends on random value RAND-A1. Each output of circuit module 108 may be coupled, preferably connected, to any of the first inputs of circuit module 108. A plurality of outputs may be coupled to a same first input. It is possible for certain first inputs not to be coupled, for certain random values RAND-A1, to an output of circuit module 108, preferably not for all possible values of value RAND-A1. When the random value received on the second input is changed, the connections between the first inputs and the outputs are changed so as to depend on the new value RAND-A1.

In the example of FIG. 6, generator 100 comprises a circuit module 110. Circuit module 110 is configured to apply the OR function to the voltages originating from the outputs of the previous circuit module, that is, circuit module 108. Circuit module 110 comprises OR logic gates 111. Circuit module 110 comprises, for example, at least three gates 111. Circuit module 110 comprises, for example, half as many gates 111 as circuit module 108 has outputs. Each gate 111 comprises two inputs coupled, preferably connected, to outputs of circuit module 108. Preferably, each output of circuit module 108 is coupled, preferably connected, to one, preferably a single, input of a gate 111.

According to another embodiment, gates 111 may be logic gates other than OR gates. Gates 111 may, for example, be AND, NAND, or exclusive OR gates.

In the example of FIG. 6, generator 100 comprises a random switching circuit module 112. Circuit module 112 comprises first inputs and a second input. Circuit module 112 comprises, for example, as many first inputs as circuit module 110 comprises gates 111. Each first input is, for example, coupled, preferably connected, to the output of a gate 111. Each output of a gate 111 is, for example, coupled, preferably connected, to a first input of circuit module 112. The second input of circuit module 112 is configured to receive a random value RAND-A2, generated by a random value generator. The second input of circuit module 112 is, for example, coupled, preferably connected, to an output of the random number generator.

Circuit module 112 comprises outputs. Circuit module 112 comprises, for example, a number of outputs different from, for example greater than, the number of inputs. Each output of circuit module 112 is coupled, preferably connected, to a first input of circuit module 112. The first input to which is coupled, preferably connected, each output depends on random value RAND-A2. Each output of circuit module 112 may be coupled, preferably connected, to any of the first inputs of circuit module 112. A plurality of outputs may be coupled to a same first input. Certain first inputs may not be coupled, for certain random values RAND- A2, to an output of circuit module 112, preferably not for all possible values of value RAND-A2. When the random value received on the second input is modified, the connections between the first inputs and the outputs are changed to depend on the new value RAND-A2.

Generator 100 comprises a random voltage conversion ("level shifter") circuit module 114. Circuit module 114 is configured to modify the voltage amplitude of the input signals according to a random value. More specifically, circuit module 114 comprises elements 115, each being a voltage conversion circuit configured to modify the amplitude of a voltage according to a random value. Circuit module 114 comprises p elements 115, value p being preferably greater than or equal to 3. Circuit module 114 preferably comprises as many elements 115 as circuit module 112 has outputs. Each element 115 has a first input, for example coupled, preferably connected, to an output of circuit module 112, and a second input configured to receive a random value (RAND-LS1, RAND-LS2, RAND-LS3, RAND-LSp). Each element 115 is configured to add to the voltage received on the first input a voltage having its value, positive or negative, depending on the random value received on the second input.

In the example of FIG. 6, generator 100 comprises a circuit module 116. Circuit module 116 comprises first and second inputs. Circuit module 116 comprises as many first inputs as circuit module 115 comprises elements 115. Each first input of circuit module 116 is coupled, preferably connected, to an output of circuit module 114, that is, to an output of an element 115. Circuit module 116 comprises, for example, as many second inputs as first inputs. The second inputs are configured to receive distinct random numbers (RAND-C1, RAND-C2, ..., RAND-Cp). Thus, the first inputs are preferably coupled, preferably connected, to outputs of the random number generator.

Circuit module 116 comprises outputs. Circuit module 116 preferably comprises as many outputs as first inputs. Each output of circuit module 116 is coupled, preferably connected, to one, preferably a single, first input of circuit module 116. Each first input of circuit module 116 is coupled, preferably connected, to one, preferably a single, output of circuit module 116. Circuit module 116 comprises elements 117, for example as many elements 117 as there are outputs of circuit module 116. Each output of circuit module 116 is coupled, by an element 117, to a reference node 117a, for example ground.

Each element 117 receives a random number. More precisely, each element 117 comprises a first input coupled, preferably connected, to an output of circuit module 116 and a second input coupled, preferably connected, to a second input of circuit module 116, and thus receiving a random number (RAND-C1, RAND-C2, ..., RAND-Cp). Elements 117 are capacitive elements. The capacitance of each element 117 depends on the random number received by said element 117. For example, each element 117 comprises a plurality of branches comprising a switch and a capacitor coupled in series, the control of the switches depending on the random number supplied to element 117. Thus, the random number received at the input of an element 117 determines which switches are off and which switches are off, and thus determines the total capacitive value of element 117.

According to an example, elements 117 are identical to one another. According to another example, elements 117 are different from one another. The number of capacitors and the capacitances of the capacitors are, for example, different.

In the example of FIG. 6, generator 100 comprises a random switching circuit module 118. Circuit module 118 comprises first inputs and a second input. Circuit module 118 comprises, for example, as many first inputs as circuit module 116 comprises outputs. Each first input is for example coupled, preferably connected, to an output of circuit module 116. Each output of circuit module 116 is, for example, coupled, preferably connected, to a first input of circuit module 118. The second input of circuit module 118 is configured to receive a random value RAND-A3, generated by a random value generator. The second input of circuit module 118 is, for example, coupled, preferably connected, to an output of the random number generator.

Circuit module 118 comprises outputs. Circuit module 118 comprises, for example, a number of outputs different from, for example greater than, the number of inputs. Preferably, circuit module 118 comprises N outputs. Each output of circuit module 118 is coupled, preferably connected, to a first input of circuit module 118. The first input to which each output is coupled, preferably connected, depends on random value RAND-A3. Each output of circuit module 118 may be coupled, preferably connected, to any of the first inputs of circuit module 112. A plurality of outputs may be coupled to a same first input. It is possible for certain first inputs not to be coupled, only for certain random values RAND-A3, to an output of circuit module 112, preferably not for all possible values of value RAND-A3. When the random value received on the second input is changed, the connections between the first inputs and the outputs are changed so as to depend on the new value RAND-A3.

The outputs of circuit module 118 are coupled, preferably connected, to the outputs of generator 100. Thus, voltages VRAND1, VRAND2, VRAND3, ..., VRANDN are generated on the outputs of circuit module 118.

All random values RAND-DIV, RAND-D1, RAND-D2, RAND-D3, ..., RAND-Dm, RAND-A1, RAND-A2, RAND-A3, RAND-LS1, RAND-LS2, ..., RAND-LSp, RAND-C1, RAND-C2, ..., RAND-Cp, are preferably distinct. Thus, although at a given time, two random values may be equal, they may preferably have different values at another time. Alternatively, the random values of different circuit modules may be equal to one another. Preferably, the random values of a same circuit module are distinct.

FIG. 7 illustrates the operation of the generator of FIG. 6. More precisely, FIG. 7 is a timing diagram comprising: a curve 120 illustrating the variations of clock signal CLK; a curve 122 illustrating the variations of signal CLK-DIV resulting from the application of signal CLK to the input of circuit module 104; a curve 124 illustrating the variations of signal CLK-D1 resulting from application of signal CLK-DIV to the input of an element 107; a curve 126 illustrating the variations of voltage V1 resulting from the application of the signal illustrated by curve 124 to the input of an element 115; a curve 128 illustrating the variations of voltage VRAND resulting from the application of the signal illustrated by curve 126 to the input of an element 117; a curve 130 illustrating the current IL generated by the laser beam; and a curve 132 illustrating current Iph.

Curve 120 shows clock signal CLK. Signal CLK is a periodic square-wave signal having a constant period P.

Curve 122 shows the signal CLK-DIV corresponding to signal CLK after a division of its frequency depending on a variable random number. Thus, between times t0 and t1, signal CLK-DIV has a frequency equal to half the frequency of signal CLK. Between times t1 and t2, signal CLK-DIV has a frequency equal to the frequency of signal CLK divided by one. After time t2, signal CLK-DIV has a frequency equal to the frequency of signal CLK divided by five.

Curve 124 illustrates the signal resulting from the application of signal CLK-DIV to the input of an element 107, that is, an element causing a random delay. Thus, the rising edge of signal CLK-DIV located at time t0 is delayed by a delay D1 determined by the random number received by element 107, and is thus placed at a time t3. The rising edge of signal CLK-DIV located at time t1 is delayed by a delay D2, shorter than delay D1, the random number having changed, and is thus placed at a time t4. The rising edge of signal CLK-DIV at time t2 is delayed by a delay D3, longer than delay D2, the random number having changed, and is thus placed at a time t5.

Curve 126 illustrates the variations of signal V1 resulting from the application of signal CLK-D1 to the input of a voltage conversion element 115. Thus, voltage V1 takes, at the rising edge of time t3, a first value depending on the random number received by element 115, for example, equal to 0.3 V. Voltage V1 takes, at the rising edge of time t4, a second value different from the first value, the random number having changed, for example, equal to 0.2 V. Voltage V1 takes, at the rising edge of time t5, a third value different from the second value, the random number having changed, for example, equal to 0.1 V.

Curve 128 illustrates the variations of voltage VRAND resulting from the application of voltage V1 to the input of a capacitive element 117. At times t3, t4, and t5, the capacitors of element 117 charge. Voltage VRAND thus progressively increases to reach the value of voltage V1. Similarly, at times t6 and t7, corresponding to the falling edges of voltage V1, the capacitors of element 117 discharge. Voltage VRAND thus progressively decreases to reach the value of voltage V1. The charge and discharge times depend on the values of the random number received by element 117, and are thus different from one another.

At a time t8, a laser beam is applied to the vicinity of a logic gate protected against laser scanning, such as described in relation with FIG. 2. The laser beam is removed at a time t9. Thus, before time t8, current IL is equal to a low value I0, for example a zero value. At time t8, current IL progressively increases to reach a high value I1. The high value depends on the state of the logic gate. At time t9, current IL progressively decreases to reach low value I0.

Current Iph corresponds to the current flowing through diode 32 when voltage VRAND is applied to the cathode of diode 32. Current Iph has, before time t8, a low value, for example a zero value. From time t8 onwards, the value of current Iph increases and decreases in a way determined by the variations of voltage VRAND, and thus determined by the random values of generator 100.

Current IGND, that is, the current measured during a laser scanning attack, is the sum of currents IL and Iph. Thus, the variations caused by current Iph make it difficult to determine the high value depending on the state of the logic gate. It is thus difficult to determine the state of the logic gates.

An advantage of the described embodiments is that it is more difficult for an individual to determine the values contained in the logic circuits by performing a laser scanning.

A further advantage of the described embodiments is that different Iph currents are generated on the different diodes 32 associated with the different logic gates. Thus, it is not possible to use the values obtained on different logic gates to determine the current values corresponding to the different logic states.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. An electronic device, comprising:
a logic gate having a power supply node coupled to a first node of application of a power supply reference voltage;
a random voltage generator configured to generate a random voltage at a second node;
a first diode having a cathode coupled to the second node and an anode coupled to the first node.

2. The device according to claim 1, wherein the logic gate has a further power supply node coupled to receive a power supply voltage.

3. The device according to claim 1, wherein the logic gate is a circuit comprising one of: a logic inverter gate, a logic AND gate, a logic NAND gate, an inclusive OR gate, an inclusive NOR gate, an exclusive OR gate, or an exclusive NOR gate.

4. The device according to claim 1, wherein the device comprises a first region comprising a plurality of logic gates and a plurality of first diodes.

5. The device according to claim 4, wherein a density of first diodes is greater than five per mm² in the first region.

6. The device according to claim 4, wherein the plurality of first diodes comprises at least two first diodes having different dimensions.

7. The device according to claim 6, wherein the at least two first diodes have different structures.

8. The device according to claim 4, wherein at least one first diode comprises a PN junction formed between a well of a first conductivity type and a substrate of the device of a second conductivity type, opposite to the first conductivity type.

9. The device according to claim 4, wherein at least one first diode comprises a PN junction formed between a first well of a first conductivity type and a second well of a second conductivity type, opposite to the first conductivity type, the second well being located in the first well.

10. The device according to claim 1, wherein the random voltage generator is configured to generate at least two distinct random voltages, each of the random voltages being applied to the cathode of at least one first diode.

11. The device according to claim 10, wherein the random voltage generator comprises:
an input coupled to a node of application of a clock signal; and
at least one circuit module configured to receive as an input a random number and to modify the clock signal as a function of a random number.

12. The device according to claim 10, wherein the random voltage generator comprises:
an input coupled to a node of application of a clock signal; and
a circuit module configured to modify an amplitude of the clock signal as a function of a random number.

13. The device according to claim 10, wherein the random voltage generator comprises:
an input coupled to a node of application of a clock signal; and
a circuit module configured to divide a frequency of the clock signal.

14. The device according to claim 10, wherein the random voltage generator comprises at least one random switching circuit module.

15. The device according to claim 10, wherein the random voltage generator comprises:
an input coupled to a node of application of a clock signal; and
a circuit module configured to add a delay to the clock signal.

16. A method of use of an electronic device that includes a logic gate having a first power supply node of application of a power supply reference voltage, a random voltage generator; and a first diode having a cathode and an anode connected to the first power supply node, the method comprising:
applying with the random voltage generator a random voltage to the cathode of the first diode; and
applying the power supply reference voltage to the anode of the first diode.

17. The method according to claim 16, wherein the logic gate is a circuit comprising one of: a logic inverter gate, a logic AND gate, a logic NAND gate, an inclusive OR gate, an inclusive NOR gate, an exclusive OR gate, or an exclusive NOR gate.

18. The method according to claim 16, further comprising generating with the random voltage generator to the random voltage by:
receiving a clock signal; and
receiving a random number; and
modifying the clock signal as a function of a random number.

19. The method according to claim 18, wherein modifying comprises one of dividing a frequency or adding a delay.

20. The method according to claim 16, further comprising generating with the random voltage generator to the random voltage by:
receiving a clock signal;
receiving a random number; and
modifying an amplitude of the clock signal as a function of the random number.
